(19) United States
(12) Patent Application Publication
(10) Pub. No.: US 2018/0101804 A1
(43) Pub. Date: Apr. 12, 2018

(54) IMPACT IDENTIFICATION OF NEW PRODUCT

(71) Applicant: International Business Machines Corporation, Armonk, NY (US)

(72) Inventors: Pankaj S. Dayama, Bangalore (IN); John Jeffrey Dillon, Markham (CA); Vinayaka Pandit, Bangalore (IN); Santosh Ravi Kiran Penubothula, Bangalore (IN); Soumitra Sarkar, Cary, NC (US)

(21) Appl. No.: 15/290,797

(22) Filed: Oct. 11, 2016

(51) Int. Cl. G06Q 10/06; G06Q 30/02; G06Q 40/08; G06Q 10/00; G06N 99/00

(52) U.S. Cl. CPC G06Q 10/06375; G06Q 30/0202; G06N 99/005; G06Q 40/08; G06Q 10/20; G06Q 10/0635

(57) ABSTRACT

One embodiment provides a method, including: utilizing at least one processor to execute computer code that performs the steps of: identifying a new product launch having a predetermined time frame; identifying at least one existing maintenance contract expiring within the predetermined time frame; generating at least one machine learning model, wherein the at least one machine learning model identifies influence of the new product launch on an existing contract; determining, using the at least one machine learning model, impact of the new product launch on revenue received from the at least one existing maintenance contract; and providing a recommendation to a user, wherein the recommendation identifies prioritization of the at least one existing maintenance contract with respect to other actions based upon the new product launch. Other aspects are described and claimed.

### BACKGROUND

In traditional contracts for equipment between a buyer and seller, equipment is purchased by the buyer. If a buyer needs a large amount of equipment the upfront cost for purchasing all the necessary equipment may be very large. Additionally, in some industries the equipment becomes obsolete very quickly and a business may want to keep up with the latest technology. Thus, the business may have to incur large expenses for updating equipment every few years if not sooner. Additionally, in traditional contracts, the buyer is responsible for the maintenance and upkeep of the equipment because the buyer owns the equipment. In some cases, the buyer can purchase a maintenance contract, but not all sellers may be willing to provide such a contract, leaving the buyer to find another method for having maintenance performed on the equipment.

Accordingly, more and more businesses are trending towards annuity-based contracts. For example, annuity-based contracts are common in computer support services, heavy equipment manufacturing, health-care equipment vendors, and the like. In an annuity-based contract, a seller or vendor, in addition to selling or leasing the equipment, also includes a maintenance contract. Annuity-based contracts are desirable for many different reasons. For example, in some industries the equipment may be complex and the buyer does not want to learn how to perform maintenance on the equipment. As another example, the buyer may have a large amount of equipment that needs maintenance performed and it may be cheaper for the buyer to hire someone to perform the maintenance on the equipment, rather than hiring an entire team or department to perform the maintenance. The sellers of the equipment also find annuity-based contracts to be desirable, because along with the purchase contract for the equipment, the seller or vendor can sell or provide a maintenance contract for maintaining the equipment.

### BRIEF SUMMARY

In summary, one aspect of the invention provides a method, comprising: utilizing at least one processor to execute computer code that performs the steps of: identifying a new product launch having a predetermined time frame; identifying at least one existing maintenance contract expiring within the predetermined time frame; generating at least one machine learning model, wherein the at least one machine learning model identifies influence of the new product launch on an existing contract; determining, using the at least one machine learning model, impact of the new product launch on revenue received from the at least one existing maintenance contract; and providing a recommendation to a user, wherein the recommendation identifies prioritization of the at least one existing maintenance contract with respect to other actions based upon the new product launch.

Another aspect of the invention provides an apparatus, comprising: at least one processor; and a computer readable storage medium having computer readable program code embodied therewith and executable by the at least one processor, the computer readable program code comprising: computer readable program code that identifies a new product launch having a predetermined time frame; computer readable program code that identifies at least one existing maintenance contract expiring within the predetermined time frame; computer readable program code that generates at least one machine learning model, wherein the at least one machine learning model identifies influence of the new product launch on an existing contract; computer readable program code that determines, using the at least one machine learning model, impact of the new product launch on revenue received from the at least one existing maintenance contract; and computer readable program code that provides a recommendation to a user, wherein the recommendation identifies prioritization of the at least one existing maintenance contract with respect to other actions based upon the new product launch.

An additional aspect of the invention provides a computer program product, comprising: a computer readable storage medium having computer readable program code embodied therewith, the computer readable program code executable by a processor and comprising: computer readable program code that identifies a new product launch having a predetermined time frame; computer readable program code that identifies at least one existing maintenance contract expiring within the predetermined time frame; computer readable program code that generates at least one machine learning model, wherein the at least one machine learning model identifies influence of the new product launch on an existing contract; computer readable program code that determines, using the at least one machine learning model, impact of the new product launch on revenue received from the at least one existing maintenance contract; and computer readable program code that provides a recommendation to a user, wherein the recommendation identifies prioritization of the at least one existing maintenance contract with respect to other actions based upon the new product launch.

A further aspect of the invention provides a method, comprising: obtaining information from a plurality of data sources to identify a new product launch and at least one existing revenue stream; identifying features of the new product launch and at least one existing revenue stream; generating, using the identified features, at least one prediction model for predicting the impact of the new product launch on the at least one existing revenue stream; and providing, based upon the impact of the new product launch, prioritization of the at least one existing revenue stream with respect to other actions and an identification of the features used in providing the prioritization of the at least one existing revenue stream.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of identifying the impact of a new product on an existing contract.

FIG. 2 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Any reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

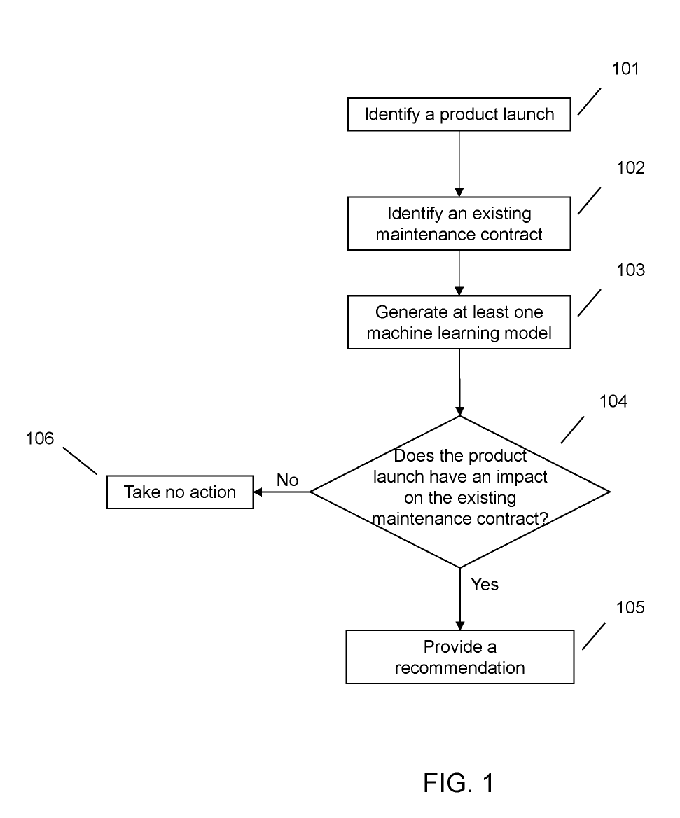

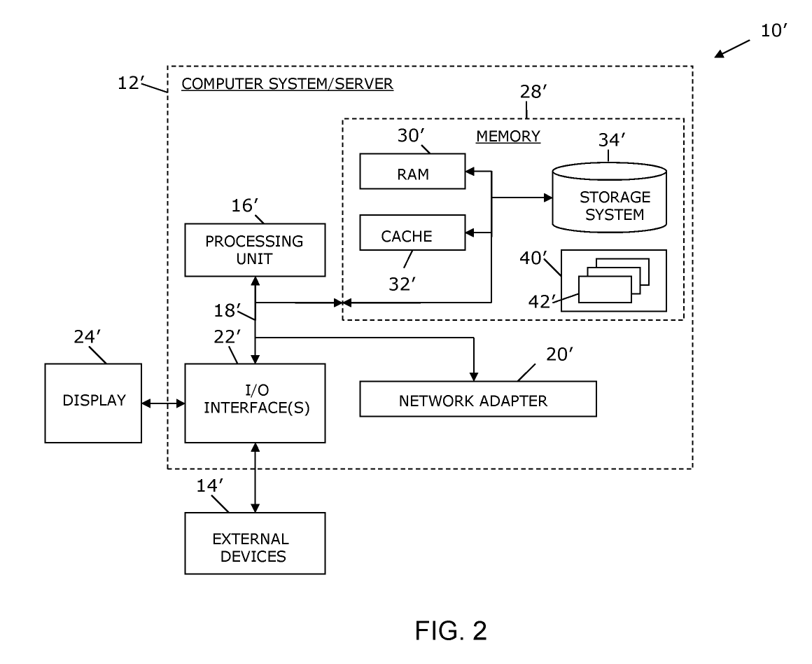

Specific reference will be made here below to FIGS. 1-2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 2. In accordance with an example embodiment, most if not all of the process steps, components and outputs discussed with respect to FIG. 1 can be performed or utilized by way of a processing unit or units and system memory such as those indicated, respectively, at 16′ and 28′ in FIG. 2, whether on a server computer, a client computer, a node computer in a distributed network, or any combination thereof.

With annuity-based contracts the sellers or vendors (hereinafter “seller”) provide a maintenance contract to service the equipment sold or leased under the annuity-based contract. Generally, the maintenance contracts associated with the annuity-based contract have a predetermined term (e.g., year, month, three years, etc.). At the end of the term, the buyer or lessee (hereinafter “buyer”) may choose to renew the contract. Techniques for predicting contract renewal risks exist. However, they operate at a macro-level for large contracts, for example, contracts for a relatively small number of high value contracts. Large contracts are typically different from annuity-based contracts, because the annuity-based contracts generally cover many small contracts, for example, one contract per group or unit, one contract per department, one contract per piece of equipment, and the like. Additionally, the seller, in addition to providing and fulfilling maintenance contracts, is also generally involved in the development and release of new products. Thus, the seller has the challenge of balancing competing revenue pressures from new product development groups and product maintenance groups. With the many small contracts, a new and different approach is required where just predicting contract renewal risk may not be helpful. Instead, a seller needs a prioritized list of different contracts and work orders to focus on, based upon the risks and actionable insights provided by the systems and methods described herein.

Traditional techniques for predicting contract non-renewal risks generally use analytics to analyze the client and contract data to predict if the contract is going to be renewed or not. Accordingly, the traditional techniques fail to provide reasons for the contract renewal risk predictions. For example, the traditional techniques do not identify if one product has an impact on the non-renewal risk of a maintenance contract for another product. Traditional predictive analytic techniques may identify opportunities for up-sell of service-level agreements, but such analysis can only be completed on existing contracts. Therefore, traditional techniques also fail to provide guidance or recommendations for mitigating the risk of losing an annuity-based or maintenance contract across multiple divisions of a company. For example, traditional techniques fail to provide a recommendation of delaying a new product launch in order to ensure the renewal of a maintenance contract. Further, traditional techniques for predicting non-renewal risk fail to assist a seller in financial planning to balance the non-renewal of an existing contract with the introduction of new revenue-generating products.

Accordingly, an embodiment provides a method of identifying an impact of a new product introduction on existing maintenance or annuity-based contracts. Once the possible impact has been identified, an embodiment may provide recommendations on methods for reducing or mitigating the non-renewal risk. An embodiment may receive information identifying a new product or new product launch having a predetermined time frame. For example, the information may identify that a new product is planned to be launched on a particular day, within a time range (e.g., in four to six months), within a particular month, and the like. An embodiment may also receive information identifying at least one existing maintenance contract that expires within the time frame that the product will be launched. For example, if the product will be launched within two months, an embodiment may identify the maintenance contracts which will be expiring within the two months.

An embodiment may generate at least one machine learning model that identifies the influence of a new product on an existing product. For example, using the identified new product launch and identified existing maintenance contract, a machine learning model may be used to identify the influence of the new product on the existing contract. In one embodiment, features may be extracted from the new product launch information and the existing maintenance contract information and a machine learning model may be generated based upon these extracted features. One machine learning model, also referred to herein as a prediction model, may include a model for predicting the risk of non-renewal of the contract. The predicted risk of non-renewal of an existing contract may be based upon the introduction of the new product into the revenue stream. One machine learning model may additionally include a prediction model for predicting an up-sell opportunity related to the existing maintenance contract. The up-sell opportunity may be based upon the introduction of the new product. In one embodiment, more than one machine learning model may be generated for both tasks—non-renewal prediction and upsell prediction. Both machine learning models for a given task may generate predictions. One of the models may be built for higher accuracy and the second model may be built for interpretability (e.g., identifying which features influence a given prediction, etc.).

An embodiment may then use the predictions to provide a recommendation to a user. The recommendation may identify a time period for the new product launch in order to reduce the impact on the revenue received from the annuity-based contract. The recommendation may also include a recommendation on contract prioritization, a recommendation for mitigating the risk of non-renewal, a recommendation for improving the financial planning to optimize the combined new product and maintenance revenues, or the like. In the case that more than one machine model is generated for a given task, the predictions from one model may be used by the system to provide a recommendation for prioritizing the contracts. The predictions from the second model may then be used to identify the features of the new product launch and existing maintenance contract which caused the resulting prediction.

Such a system provides a technical improvement over current systems for predicting non-renewal risks of annuity-based or maintenance contracts. The system provides an analysis tool that can be applied to small contracts as opposed to the traditional techniques that are only effective for large contracts. Additionally, the system provides a seller with insight on reasons for the risk predictions, which allows the seller or system to identify what features should be addressed to assist in mitigating the risk. An embodiment may provide recommendations to the seller regarding actions to be taken to mitigate the risk of non-renewal of the annuity-based contract.

The system as described herein additionally provides a technical improvement over current systems by incorporating a new product into the predictive model and identifying how the new product will affect the renewal of a maintenance contract. Using this information, the system can recommend a delay of a new product launch until after the maintenance contract has been renewed. Alternatively, rather than delaying the new product launch, an embodiment could provide recommendations on opportunities to provide a different annuity-contract in light of the new product. Thus, the system and methods as described herein provide a technical improvement to traditional techniques and methods for predicting the risk of non-renewal of a contract and also provide recommendations for balancing the revenue impact of a new product on an annuity maintenance stream.

Referring now to FIG. 1, at 101 an embodiment may identify a new product launch having a predetermined time frame. The predetermined time frame may be a particular day (e.g., Apr. 1, 2025, next Thursday, etc.), a time range (e.g., in the next two to four months, within the year, etc.), or the like. In identifying a new product launch, an embodiment may access different information sources. For example, the system may access the Internet, other systems of the company, other data storage locations, and the like. Additionally, or alternatively, the information may be provided to the system. For example, a user may upload the information to the system, the user may manually enter the information into the system, or the like. The different information sources may include other systems of the company, for example, service request systems which may identify existing contracts, requests for services, and the like, company financial systems, service-level agreement systems, and the like. Other information sources may include news articles from the Internet, other remote data storage locations, local data storage, and the like.

At 102, an embodiment may identify at least one existing maintenance contract expiring within the predetermined time frame corresponding to the new product launch time frame. In identifying at least one existing maintenance contract, an embodiment may use some of the same sources used for identifying the new product launch. For example, an embodiment may access the contracting system to determine which existing contracts are expiring or up for renewal between now and the time that the new product launch is to occur. As an example, the new product may be launching within the next three months. An embodiment may then identify the maintenance or annuity-based contracts which are expiring within the next three months.

At 103, an embodiment may generate at least one machine learning model that identifies an influence of a product on an existing contract. To generate a machine learning model specific to the identified new product launch and the identified existing maintenance contracts, an embodiment may extract features from the information regarding the new product launch and the existing maintenance contracts. Features of the new product launch and maintenance contracts may include the date of the launch and date of the expiration of the contract, the product covered by the contract, a similarity of the new product to the product within the existing contract, a vendor of the new product and existing contracts, the financials associated with the new product and existing contracts (e.g., the amount of the contract, how much the new product costs, etc.), the number of products covered by the contract, the service provided under the contract, and the like.

To extract the features, an embodiment may parse and mine information from the data sources. For example, an embodiment may mine a news article to identify a new product and the expected launch date of the new product. As another example, an embodiment may parse the text of an existing contract to identify the type of product covered by the annuity-based contract. The features may also identify the trend associated with the particular type of contract. For example, using historical data an embodiment may determine that contracts for maintenance services covering printers are typically renewed for a five-year span. As another example, using historical data an embodiment may determine that maintenance contracts for products in which a new product is launched have a 30% chance of being renewed. The features may then be used to generate at least one machine learning model specific to the particular product and existing contracts.

The machine learning model may include a model for predicting a non-renewal risk of an existing contract, or, in the alternative, an erosion risk associated with the existing contract. Not only can this machine learning model predict the non-renewal risk, but, because the machine learning model includes the information related to the new product launch and the existing contracts, the non-renewal risk is specifically based upon the introduction of the new product. Thus, if a new product has a high influence on the possibility of a renewal of the contract, this influence will be reflected by the machine learning model. In one embodiment, the machine learning model may include a model for predicting an up-sell opportunity based upon the influence of a product on an existing contract.

In one embodiment, more than one machine learning model may be generated. For example, one embodiment may generate two machine learning models for each task (e.g., contract non-renewal, upsell prediction, etc.). One machine learning model may include a highly accurate prediction model and the other machine learning model may include an interpretable model. The highly accurate prediction model may perform predictions with high accuracy, but cannot explain or identify the features or factors which influence the prediction. The interpretable model may perform predictions which are not as accurate, but which can explain the features or factors which influence the prediction. When the predictions of both models match for a given contract or task, the results of the models can be combined. Such a combination results in a prediction that is both accurate and interpretable, which provides a confidence in the prediction and also determines the key features or factors which resulted in the prediction.

Using the machine learning model(s) generated at 103, an embodiment may determine, at 104, whether the new product launch identified at 101 has an impact on the maintenance contract(s) identified at 102. An impact on the maintenance contract may include an identification of how much the new product launch influences the risk of non-renewal of the contract. For example, a new product launch may cause all maintenance contracts of similar products to not be renewed. As another example, a new product launch may cause no change in the risk that a contract will not be renewed. The impact may be identified as a particular number value (e.g., 50% impact, a number on a scale, etc.), a word value (e.g., high impact, low impact, etc.), a range, and the like. The impact may also be identified as a change in the risk. For example, with no new product launch the risk for non-renewal of a contract may be low. However, with a new product launch the risk for non-renewal of the same contract may be high. Thus, the impact may be identified as this increase from a low risk to a high risk.

In cases where more than one machine learning model is generated, for example, the accurate prediction model and the interpretable model, the results from both models may be compared. In cases where the predictions of both models match, the predictions from the accurate prediction model may be used to prioritize the contracts. The results from the interpretable model may then be used to identify the feature or features which influenced the prediction. For example, the prediction from both models may be that the risk of contract erosion is very high. Since the prediction is the same from both models, the system has a high confidence that the prediction (i.e., in this example, that the risk of contract erosion is very high) is very accurate. The interpretable model may then determine the features or factors that are causing the risk of contract erosion to be very high. For example, the interpretable model may identify that the new product launch is a factor in causing the risk of contract erosion to be very high. The interpretable model may also identify other factors that cause the prediction. For example, the interpretable model may identify that the features that most influence the prediction is that the buyer is trying to reduce overhead costs and has placed no service calls in the past two service cycles.

If it is determined that the new product launch has no impact on the existing contracts, the system may take no action at 106. Alternatively, the system may provide this information to a user, for example, through a display, notification window, graphical user interface, and the like. If, however, it is determined that the new product launch has an impact on the existing maintenance contract at 104, an embodiment may provide a recommendation to a user at 105. The recommendation may include a prioritization of the maintenance contracts for the seller to focus on based upon the impact of the new product launch. For example, the system may identify that Contract A will be the most affected by the new product launch. Therefore, the seller should focus on renewal for Contract A. As another example, the recommendation may identify that Contract A is the most impacted; however, focusing on Contract A is not the best use of resources. Therefore, the system may identify a different contract to be prioritized. The recommendation may not only be based upon the new product launch plan, but also may be based upon other features, for example, service request data for the existing contracts, client financials, other available outside vendors for the maintenance of the product, and the like.

In one embodiment, a recommendation may only be generated if the impact of the new product exceeds a particular threshold which may be set by the system or a user. The recommendation may be provided within a graphical user interface, display, pop-up window, and the like. For example, the recommendation may be provided within a guided interface for the seller. As an example, the system may include an application to be executed by a processor. The application may include fields and forms that request information from the user. When the user needs to provide an input, the system may request the input from the user. The application may also capture the information from other sources, as described above. Once the application has processed the impact, the application may provide a graphical user interface to the seller which includes a recommendation.

In one embodiment the recommendation may identify a time period for the new product launch which reduces the impact of the new product on the revenue received from the maintenance contract. For example, an embodiment may recommend that the product be launched at the end of the two to four-month range that was identified as the predetermined time frame. As another example, an embodiment may identify that if the new product launch is delayed from Apr. 1, 2020, to Jun. 1, 2020, the impact of the new product on the maintenance contract revenue will be reduced. In one embodiment the recommendation may include a prioritization of the existing maintenance contracts. For example, if the system identifies that the new product launch impacts multiple maintenance contracts, an embodiment may identify which contracts should be prioritized for mitigating the risk of contract non-renewal.

The recommendation may also include guidance for optimizing revenue. For example, if an embodiment determines that a new product launch will have a high impact on renewal of a particular maintenance contract, an embodiment may recommend that discounts be provided to incentivize the buyer into renewing the contract. An embodiment may also recommend that a lower or cheaper maintenance contract be offered to the buyer. The recommendations may be based upon the different factors that were identified as causing the prediction. For example, if the main factor identified is a low cash flow of the buyer, the recommendation may be a discounted maintenance plan. If the additional factor is identified as the buyer making few service calls during a service period, then the recommendation may be to offer a lower tier maintenance plan. The system is able to access information across multiple divisions to generate the recommendations. Thus, using the systems and methods as described herein, financial planning within and across divisions can be integrated.

As shown in FIG. 2, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
identifying a new product launch having a predetermined time frame;
identifying at least one existing maintenance contract expiring within the predetermined time frame;
generating at least one machine learning model, wherein the at least one machine learning model identifies influence of the new product launch on an existing contract;
determining, using the at least one machine learning model, impact of the new product launch on revenue received from the at least one existing maintenance contract; and
providing a recommendation to a user, wherein the recommendation identifies prioritization of the at least one existing maintenance contract with respect to other actions based upon the new product launch.

2. The method of claim 1, wherein the at least one machine learning model comprises at least two machine learning models and wherein at least one of the at least two machine learning models identifies a risk of non-renewal of an existing contract.

3. The method of claim 2, wherein a second of the at least two machine learning models identifies features that influenced the prediction of the first of the at least two machine learning models.

4. The method of claim 1, wherein the at least one machine learning model comprises a prediction model for predicting contract erosion risk.

5. The method of claim 4, wherein the impact of the new product launch comprises a risk of non-renewal of the at least one existing maintenance contract.

6. The method of claim 5, wherein the providing a recommendation comprises providing a recommendation for reducing the risk of non-renewal of the at least one existing maintenance contract.

7. The method of claim 1, wherein the at least one machine learning model comprises a prediction model for predicting an up-sell opportunity based upon the influence of a product on an existing contract.

8. The method of claim 1, wherein the recommendation is based upon at least one feature selected from the group consisting of: service request data for the at least one existing maintenance contract, financial information from a client of the at least one existing maintenance contract, and availability of outside vendors for the at least one existing maintenance contract.

9. The method of claim 1, comprising identifying features from the new product launch and at least one existing maintenance contract.

10. The method of claim 9, wherein the at least one machine learning model is based upon the identified features.

11. An apparatus, comprising:
at least one processor; and
a computer readable storage medium having computer readable program code embodied therewith and executable by the at least one processor, the computer readable program code comprising:
computer readable program code that identifies a new product launch having a predetermined time frame;
computer readable program code that identifies at least one existing maintenance contract expiring within the predetermined time frame;
computer readable program code that generates at least one machine learning model, wherein the at least one machine learning model identifies influence of the new product launch on an existing contract;
computer readable program code that determines, using the at least one machine learning model, impact of the new product launch on revenue received from the at least one existing maintenance contract; and
computer readable program code that provides a recommendation to a user, wherein the recommendation identifies prioritization of the at least one existing maintenance contract with respect to other actions based upon the new product launch.

12. A computer program product, comprising:
a computer readable storage medium having computer readable program code embodied therewith, the computer readable program code executable by a processor and comprising:
computer readable program code that identifies a new product launch having a predetermined time frame;
computer readable program code that identifies at least one existing maintenance contract expiring within the predetermined time frame;
computer readable program code that generates at least one machine learning model, wherein the at least one machine learning model identifies influence of the new product launch on an existing contract;
computer readable program code that determines, using the at least one machine learning model, impact of the new product launch on revenue received from the at least one existing maintenance contract; and
computer readable program code that provides a recommendation to a user, wherein the recommendation identifies prioritization of the at least one existing maintenance contract with respect to other actions based upon the new product launch.

13. The computer program product of claim 12, wherein the at least one machine learning model comprises at least two machine learning models and wherein at least one of the at least two machine learning models identifies a risk of non-renewal of an existing contract.

14. The computer program product of claim 13, wherein a second of the at least two machine learning models identifies features that influenced the prediction of the first of the at least two machine learning models.

15. The computer program product of claim 12, wherein the at least one machine learning model comprises a prediction model for predicting contract erosion.

16. The computer program product of claim 15, wherein the impact of the new product launch comprises a risk of non-renewal of the at least one existing maintenance contract and wherein the providing a recommendation comprises providing a recommendation for reducing the risk of non-renewal of the at least one existing maintenance contract.

17. The computer program product of claim 12, wherein the at least one machine learning model comprises a prediction model for predicting an up-sell opportunity based upon the influence of a product on an existing contract.

18. The computer program product of claim 12, wherein the recommendation identifies a prioritization of the at least one existing maintenance contract with respect to other actions.

19. The computer program product of claim 12, comprising identifying features from the new product launch and at least one existing maintenance contract and wherein the at least one machine learning model is based upon the identified features.

20. A method, comprising:
obtaining information from a plurality of data sources to identify a new product launch and at least one existing revenue stream;
identifying features of the new product launch and at least one existing revenue stream;
generating, using the identified features, at least one prediction model for predicting the impact of the new product launch on the at least one existing revenue stream; and
providing, based upon the impact of the new product launch, prioritization of the at least one existing revenue stream with respect to other actions and an identification of the features used in providing the prioritization of the at least one existing revenue stream.
